(19) United States
(12) Patent Application Publication
(10) Pub. No.: US 2010/0124881 A1
(43) Pub. Date: May 20, 2010

(54) Database Based Connectivity For Secure SSID

(76) Inventors: Vivekananda Uppunda, Bangalore (IN); Sandeep Ramakrishnan, Bangalore (IN); Mahalingeshwara Chambarakatta, Bangalore (IN)

Correspondence Address: MOTOROLA, INC., 1303 EAST ALGONQUIN ROAD, IL01/3RD, SCHAUMBURG, IL, 60196, US

(21) Appl. No.: 12/272,393

(22) Filed: Nov. 17, 2008

(51) Int. Cl. H04B 1/38; H04B 1/00

(52) U.S. Cl. 455/26.1; 455/73

(57) ABSTRACT

A device includes a wireless transceiver and a memory storing a database. The database includes identification information of one or more secured wireless networks. When the device attempts to establish a wireless connection, the wireless transceiver attempts to connect to the one or more secured wireless networks prior to attempting to connect to further networks.

### BACKGROUND

Wireless access points are typically identified by their service set identifier (“SSID”). Some access points broadcast their SSID, while others hide it to minimize unauthorized access. To connect to an access point that hides its SSID, a network device must send a variety of probe requests to find information concerning such access points. This process can be time-consuming and can result in poor roaming performance.

### SUMMARY OF THE INVENTION

The present invention relates to a device including a wireless transceiver and a memory storing a database. The database includes identification information of one or more secured wireless networks. When the device attempts to establish a wireless connection, the wireless transceiver attempts to connect to the one or more secured wireless networks prior to attempting to connect to further networks.

The present invention further relates to a method including receiving a request to connect to a wireless network, attempting to connect to one of a plurality of secured wireless networks corresponding to network identifiers stored in a database, and attempting to connect to at least one network not in the database, if the attempt to connect to the one of the wireless networks corresponding to the network identifiers stored in the database is unsuccessful.

The present invention further relates to a computer readable storage medium storing a set of instructions executable by a processor. The instructions are operable to receive a request to connect to a wireless network, attempt to connect to one of a plurality of secured wireless networks corresponding to network identifiers stored in a database, and attempt to connect to at least one network not in the database, if the attempt to connect to the one of the wireless networks corresponding to the network identifiers stored in the database is unsuccessful.

### BRIEF DESCRIPTION OF THE DRAWINGS

FIG. 1 shows an exemplary wireless communication network according to the present invention.

FIG. 2 shows an exemplary database storing information of secure SSID networks according to the present invention.

FIG. 3 shows an exemplary method for connecting to a secure SSID according to the present invention.

### DETAILED DESCRIPTION

The exemplary embodiments of the present invention may be further understood with reference to the following description and the appended drawings, wherein like elements are referred to with the same reference numerals. The exemplary embodiments describe systems and methods for achieving faster connectivity and improved roaming performance in networks using secure SSID. In the exemplary embodiments, mobile devices maintain a database of access points using secure SSID to improve the process of connecting to those access points.

Networks may utilize access points with secure SSID in order to minimize the occurrence of unauthorized attempts to access the network. Secure SSIDs are those which do not broadcast the SSID name in the beacon transmitted by the access point. To connect to a secure SSID, a device must send a probe request on the various allowable channels, including the SSID name, to find the details of the SSID in order to connect to the access point having the secure SSID. The details to be retrieved may include the channel of operation of the network, the MAC address, the supported data rates, etc. The necessity of transmitting probe requests on all the allowed channels until a response is received results in an increased time to connect.

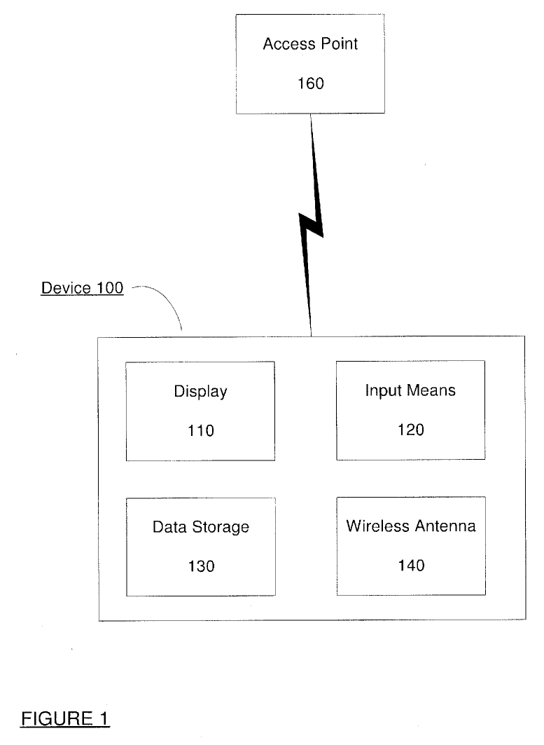

FIG. 1 illustrates a schematic view of an exemplary device 100 that may attempt to connect to a wireless local area network (“WLAN”). The device 100 may be, for example, a notebook computer, desktop computers, a handheld or palmtop computer, a portable gaming device, or any other device that may be capable of connecting to a WLAN. The device 100 may include a display 110, an input means 120 (e.g., a keyboard, a touch pad, a touch-sensitive display, etc.), data storage 130 (e.g., a hard drive), and a wireless network antenna 140. Those of skill in the art will understand that this list is intended to be illustrative rather than comprehensive, and that various devices 100 may include other components in addition to those listed above.

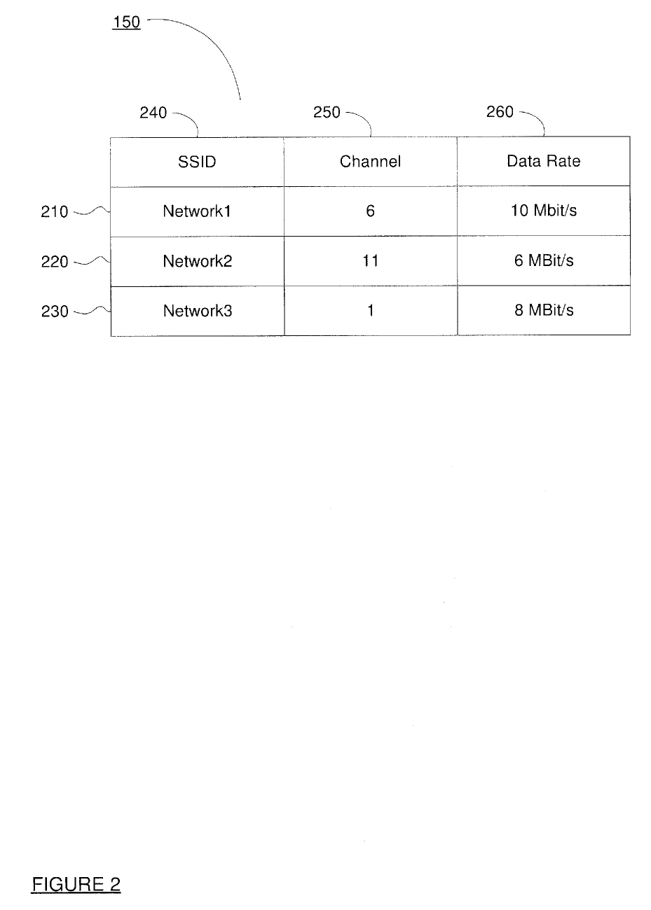

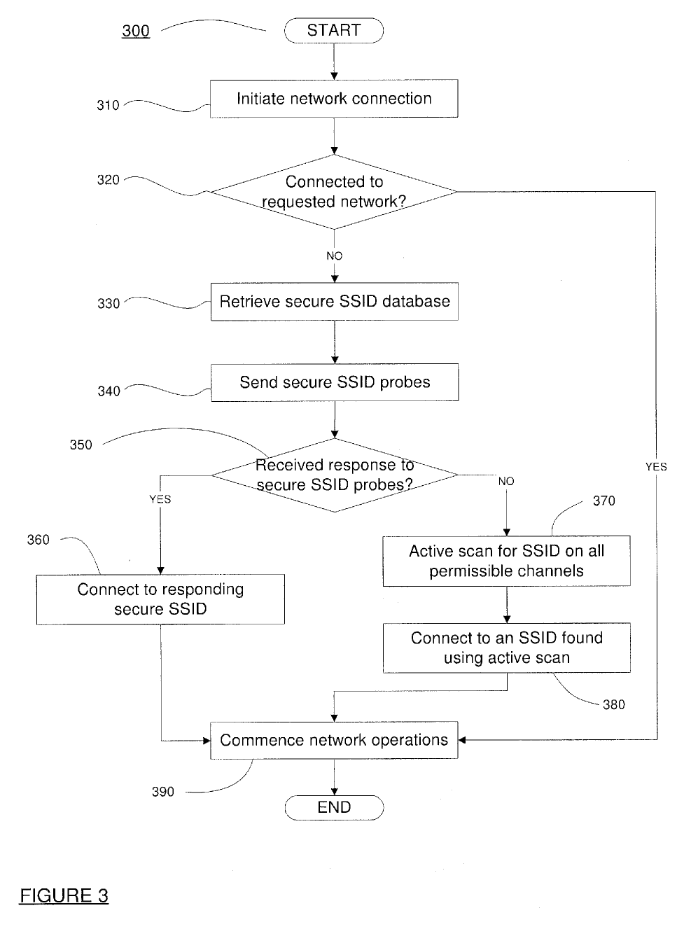

The wireless network antenna 140 enables the device 100 to communicate by various wireless networks that it may have access to. Communications may be coordinated, for example, by a drive and/or a software application stored in the data storage 130 and executed by a processor of the device 100. While this software application may be capable of communicating with a WLAN using a secure SSID by the prior method described above, the exemplary embodiments provide for improved performance. The data storage 130 stores a database 150 storing data to be described in further detail with reference to FIG. 2 below, and used in the operation of the exemplary method 300 of FIG. 3, also described below. Additionally, the data storage 130 may store an operating system, applications, documents, etc. FIG. 1 further illustrates an exemplary access point 160 with which the device 100 may communicate, and which will be referenced in the description of the exemplary method 300 below.

FIG. 2 illustrates the contents of an exemplary database 150 storing network information to aid in the connection of the device 100 to a WLAN using the exemplary method 300 described below. The database 150 stores a plurality of entries 210, 220 and 230; those of skill in the art will understand that the illustration of three database entries is only exemplary and that the precise number of entries will vary among different implementations of the database 150. Each of the entries 210, 220 and 230 stores data required for the device 100 to connect to a corresponding WLAN with a secure SSID. For example, for each of the entries 210, 220 and 230, the database 150 may include an SSID field 240, a channel field 250, a data rate field 260, etc. Those of skill in the art will understand that other fields are possible in order to facilitate the connection of the device 100 to one of the networks denoted by database entries 210, 220 and 230.

FIG. 3 illustrates an exemplary method 300 by which a mobile device (e.g., the device 100 of FIG. 1) may use an SSID database (e.g., the database 150 of FIG. 2) to facilitate its connection to a network. While the method 300 will be described herein with specific reference to the device 100 and the database 150, those of skill in the art will understand that various other devices may also be capable of performing the exemplary method 300.

In step 310, the device 100 initiates the process of connecting to a wireless network. This may be done automatically or by a user who, for example, enters a command into a software interface or engages a hardware component (e.g., a button or a switch) to begin the process, etc. In step 320, the device 100 tries to connect to an SSID via a name provided by the user or previously stored in data storage 130. This connection step may follow the standard process that is known in the art. If this connection is successful, the method continues to step 390; if not, the method proceeds to step 330, wherein the device 100 retrieves the database 150 from the data storage 130. Alternately, in another exemplary embodiment, the database 150 may be retrieved when the device 100 is powered on and may reside in active memory until it is needed.

In step 340, the device 100 transmits probe requests to secure SSIDs maintained in the database 150. These requests are typically standard probe requests known in the art (e.g., based on the 802.11 standard) but may alternately be of a proprietary format. The probe requests may contain the name of the SSID with which the device 100 wishes to connect, the channel on which it is attempting to connect, the data rates that the device 100 supports, the MAC address of the device 100, etc. Subsequently, in step 350 the device 100 listens for responses from networks with SSIDs probed in step 340. If a response is received, in step 360 the device 100 connects to an access point responding to the probe request. The connection process of step 360 follows standard methods that are well known in the art.

Alternately, if no response is received in step 350, then in step 370 the device 100 begins an active scan for network SSIDs on all permissible channels. The specific channels scanned in step 370 will depend on the country in which the device 100 is operating. Next, in step 380, the device 100 connects to a network found during the active scan in step 370. As above, this connection process may typically follow standard methods that are known in the art. Last, in step 390, which follows the connection made in step 320, 360 or 380, the device 100 may commence network operations via the SSID to which it has connected. Following step 390, the method terminates.

Those of skill in the art will understand that the same method 300, save for step 310, may be followed by a device 100 that roams out of the service area of an SSID to which it had previously been connected and needs to connect to a new SSID to continue its network operations. Initially, the database 150 may be received by the device 100 from an external source (e.g., the manufacturer of the device 100, an internet service provider, etc.). It may subsequently be updated when the device 100 receives, upon an active scan, a beacon that does not contain an SSID name.

It will be apparent to those skilled in the art that various modifications may be made in the present invention, without departing from the spirit or the scope of the invention. Thus, it is intended that the present invention cover modifications and variations of this invention provided they come within the scope of the appended claims and their equivalents.

What is claimed is:

1. A device comprising:
a wireless transceiver; and
a memory storing a database, the database including identification information of one or more secured wireless networks,
wherein, when the device attempts to establish a wireless connection, the wireless transceiver attempts to connect to the one or more secured wireless networks prior to attempting to connect to further networks.

2. The device of claim 1, wherein the wireless transceiver attempts to connect to a user requested network prior to attempting to connect to the one or more secured wireless networks.

3. The device of claim 1, wherein the identification information is an SSID.

4. The device of claim 1, wherein the database further stores connection information.

5. The device of claim 4, wherein the connection information is one of a channel and a data rate.

6. The device of claim 1, wherein when the wireless transceiver connects to one of the further networks, the device adds the one of the further networks to the database.

7. The device of claim 1, wherein the device performs an active scan when attempting to connect to further networks.

8. The device of claim 7, wherein the active scan comprises all allowable channels.

9. The device of claim 1, wherein the device sends probes when attempting to connect to the one or more secured wireless networks.

10. The device of claim 1, wherein the connection attempts use a WiFi wireless protocol.

11. A method, comprising:
receiving a request to connect to a wireless network;
attempting to connect to one of a plurality of secured wireless networks corresponding to network identifiers stored in a database; and
attempting to connect to at least one network not in the database, if the attempt to connect to the one of the wireless networks corresponding to the network identifiers stored in the database is unsuccessful.

12. The method of claim 11, wherein the identifiers are SSIDs.

13. The method of claim 11, wherein the database stores further information corresponding to the networks.

14. The method of claim 13, wherein the further information is one of a channel and a data rate.

15. The method of claim 13, wherein the database is one of received and assembled.

16. The method of claim 13, further comprising:
connecting to a further secured network not in the database; and
adding the further secured network to the database.

17. The method of claim 13, wherein the step of attempting to connect to the one of the plurality of wireless networks comprises sending probes to the wireless networks.

18. The method of claim 13, wherein the step of attempting to connect to at least one network not in the database comprises performing an active scan for available SSIDs.

19. The method of claim 18, wherein the active scan comprises all available channels.

20. A computer readable storage medium storing a set of instructions executable by a processor, the instructions operable to:
receive a request to connect to a wireless network;
attempt to connect to one of a plurality of secured wireless networks corresponding to network identifiers stored in a database; and
attempt to connect to at least one network not in the database, if the attempt to connect to the one of the wireless networks corresponding to the network identifiers stored in the database is unsuccessful.
